(19) United States
(12) Patent Application Publication
(10) Pub. No.: US 2026/0032222 A1
(43) Pub. Date: Jan. 29, 2026

(54) IMAGE QUALITY CONTROL METHOD, NON-TRANSITORY COMPUTER-READABLE STORAGE MEDIUM STORING IMAGE QUALITY CONTROL PROGRAM, AND PROJECTOR

(71) Applicant: SEIKO EPSON CORPORATION, Tokyo (JP)

(72) Inventor: Kazuhiko TAKAGI, Matsumoto-shi (JP)

(73) Assignee: SEIKO EPSON CORPORATION, Tokyo (JP)

(21) Appl. No.: 19/277,942

(22) Filed: Jul. 23, 2025

(30) Foreign Application Priority Data
Jul. 24, 2024 (JP) 2024-118504

(51) Int. Cl. H04N 9/31; H04N 1/00

(52) U.S. Cl. CPC H04N 9/3179; H04N 1/00005; H04N 1/00023; H04N 1/00066; H04N 9/3105; H04N 9/3147

(57) ABSTRACT

An image quality control method includes acquiring first information indicating image quality of a first projector, acquiring second information indicating image quality, which corresponds to the first information, of a second projector different from the first projector from a database that stores the first information and the second information in association with each other, and setting the second information in the second projector.

The present application is based on, and claims priority from JP Application Serial Number 2024-118504, filed Jul. 24, 2024, the disclosure of which is hereby incorporated by reference herein in its entirety.

### BACKGROUND

### 1. Technical Field

The present disclosure relates to an image quality control method, a non-transitory computer-readable storage medium storing an image quality control program, and a projector.

### 2. Related Art

Various techniques concerning a display device have been known (see, for example, JP-A-2006-276144).

JP-A-2006-276144 display device having the following configuration. That is, the display device includes a switch provided to enable a user to operate adjustment of image quality such as luminance and contrast, an image quality instructor that outputs an instruction signal for image quality to another display device via a communicator such that the other display device has the same image quality as the image quality adjusted by the user, and an image quality adjuster that, when the instruction signal for image quality is received from the other display device via the communication unit, automatically adjusts the image quality to coincide with the image quality of the received instruction signal.

JP-A-2006-276144 is an example of the related art.

However, JP-A-2006-276144 does not describe specific means for matching image quality. For example, when manufacturers or models are different, it is likely that the image quality of another display device cannot be matched with the image quality of the display device adjusted by the user.

### SUMMARY

An aspect of the present disclosure is an image quality control method including: acquiring first information indicating image quality of a first display device; acquiring second information indicating image quality, which corresponds to the first information, of a second display device different from the first display device from a database that stores the first information and the second information in association with each other; and setting the second information in the second display device.

Another aspect of the present disclosure is a non-transitory computer-readable storage medium storing an image quality control program for causing a processor to execute: acquiring first information indicating image quality of a first display device; acquiring second information indicating image quality, which corresponds to the first information, of a second display device different from the first display device from a database that stores the first information and the second information in association with each other; and setting the second information in the second display device.

Still another aspect of the present disclosure is a projector including: an optical device configured to project a projection image; and at least one processor configured to execute: acquiring first information indicating image quality of a projection image of another projector; acquiring second information indicating image quality of a projection image of a projector different from the other projector from a database that stores the first information and the second information in association with each other; and projecting the projection image from the optical device based on the second information.

### BRIEF DESCRIPTION OF THE DRAWINGS

FIG. 1 is a diagram illustrating an example of a configuration of an image quality control system according to a first embodiment.

FIG. 2 is a diagram illustrating an example of a configuration of a projector.

FIG. 3 is a diagram illustrating an example of a configuration of a first controller of a second projector.

FIG. 4 is a table illustrating an example of a configuration of a database. FIG. 5 is a screen diagram illustrating an example of a user input screen.

FIG. 6 is a flowchart illustrating an example of processing of the first controller of the second projector.

FIG. 7 is a diagram illustrating an example of a configuration of an image quality control system according to a second embodiment.

FIG. 8 is a diagram illustrating an example of a configuration of a third controller of a smartphone.

FIG. 9 is a screen diagram illustrating an example of a display screen of a first projector.

FIG. 10 is a diagram illustrating an example of a configuration of an image quality control system according to a third embodiment.

FIG. 11 is a diagram illustrating an example of a configuration of the third controller of the smartphone.

### DESCRIPTION OF EMBODIMENTS

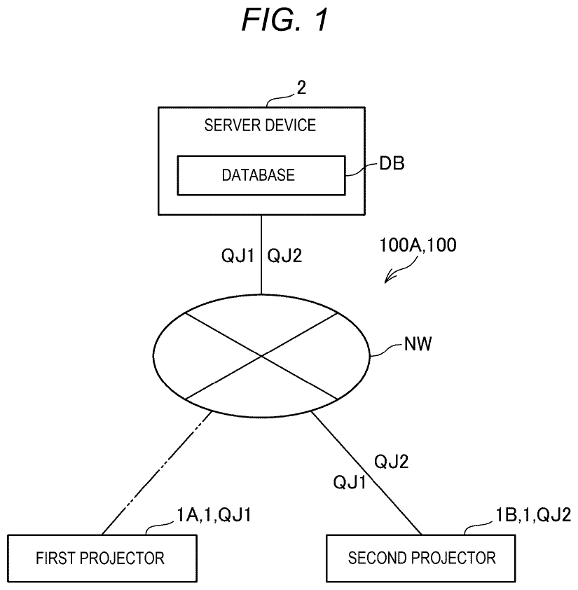

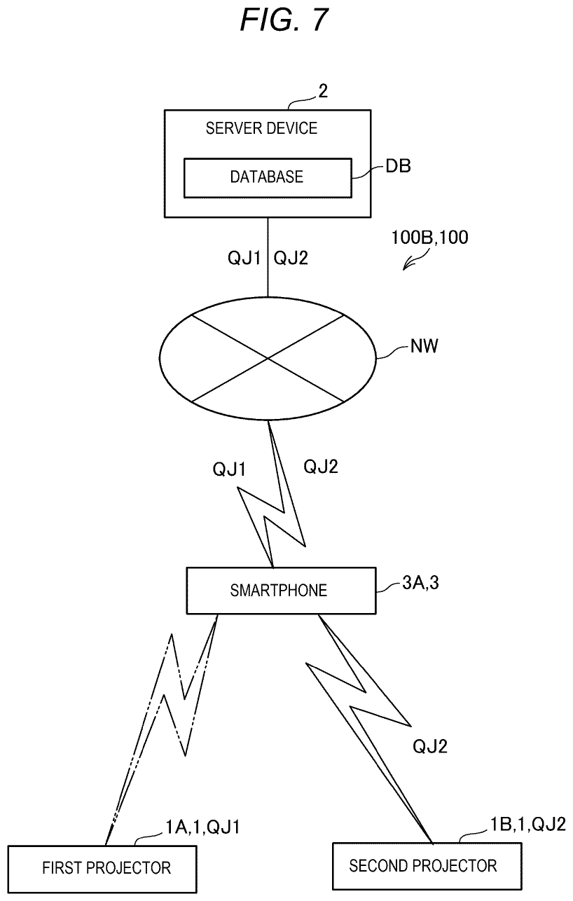

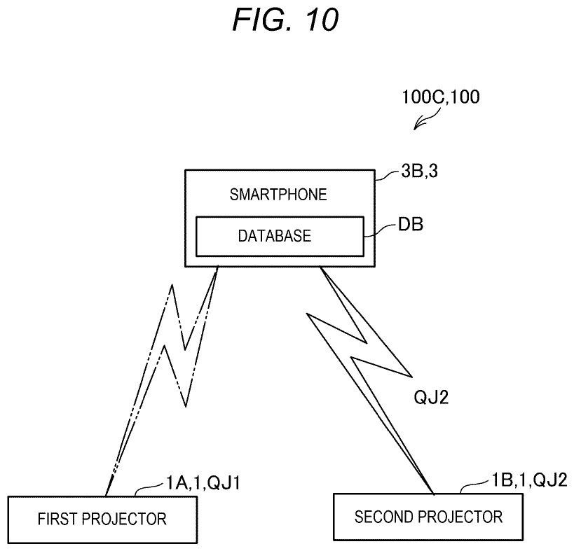

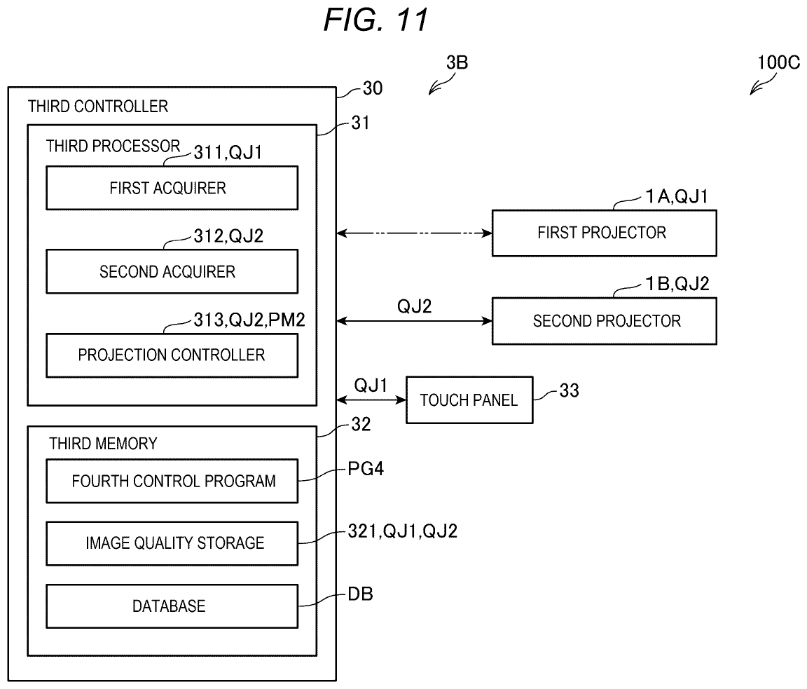

Embodiments of the present disclosure are explained below with reference to the drawings. An image quality control system 100 according to the embodiments includes an image quality control system 100A according to a first embodiment explained with reference to FIGS. 1 to 6, an image quality control system 100B according to a second embodiment explained mainly with reference to FIGS. 7 to 9, and an image quality control system 100C according to a third embodiment explained mainly with reference to FIGS. 10 and 11.

### 1. First embodiment

First, the image quality control system 100A according to the first embodiment is explained with reference to FIG. 1. FIG. 1 is a diagram illustrating an example of a configuration of the image quality control system 100A according to the first embodiment.

The image quality control system 100A includes a first projector 1A, a second projector 1B, and a server device 2.

Each of the first projector 1A and the second projector 1B projects projection light PL onto a screen SC and displays a projection image PM on the screen SC.

The second projector 1B is communicably connected to the server device 2 via a network NW. The network NWA is, for example, the Internet.

The server device 2 includes a database DB that stores first information QJ1 and second information QJ2 in association with each other.

The first information QJ1 indicates image quality of the projection image PM projected by the first projector 1A.

The second information QJ2 indicates image quality corresponding to the first information QJ1 in the projection image PM projected by the second projector 1B.

In other words, the second information QJ2 indicates a setting condition for setting the second projector 1B such that the image quality of the projection image PM projected by the second projector 1B approximates the image quality of the projection image PM projected by the first projector 1A. The setting condition includes, for example, an image quality mode.

The second projector 1B acquires the first information QJ1 based on operation of a user. The second projector 1B acquires the second information QJ2 corresponding to the first information QJ1 from the server device 2. The second projector 1B projects the projection image PM corresponding to the second information QJ2.

The first projector 1A corresponds to an example of a “first display device”.

The second projector 1B corresponds to an example of a “second display device”.

The first projector 1A corresponds to an example of “another projector”.

The second projector 1B corresponds to an example of a “projector”.

In the image quality control system 100A according to the first embodiment, a case in which the server device 2 includes the database DB is explained. However, the embodiments are not limited thereto. An information processing device configured to be communicable with the second projector 1B only has to include the database DB.

Examples of the information processing device include a personal computer, a tablet device, and a smartphone. In this case, the network NW may be, for example, a local area network (LAN) or a wide area network (WAN).

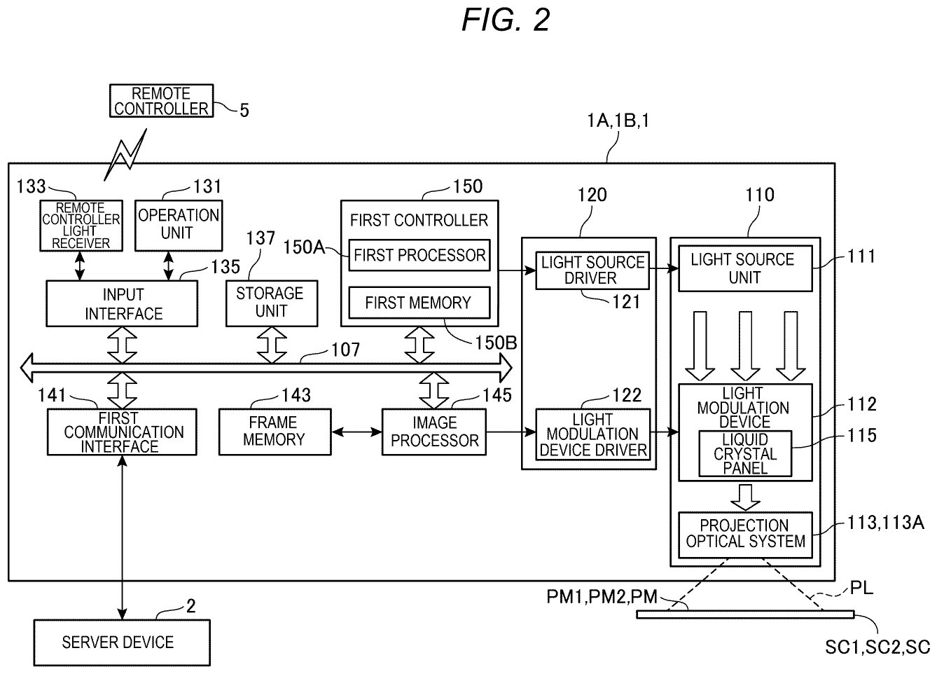

Subsequently, a configuration of a projector 1 is explained with reference to FIG. 2. FIG. 2 is a diagram illustrating an example of the configuration of the projector 1.

The first projector 1A and the second projector 1B have substantially the same configuration. Therefore, in the following explanation, when the first projector 1A and the second projector 1B are not distinguished, each of the first projector 1A and the second projector 1B is sometimes described as projector 1.

As illustrated in FIG. 2, the projector 1 includes a projection unit 110 and a driver 120 that drives the projection unit 110. The projection unit 110 forms an optical image and projects projection light PL onto the screen SC. In the present embodiment, the projection unit 110 projects the projection light PL corresponding to image data onto the screen SC according to an instruction of a first controller 150.

The projection unit 110 includes a light source unit 111, a light modulation device 112, and a projection optical system 113. The driver 120 includes a light source driver 121 and a light modulation device driver 122.

The projection unit 110 corresponds to an example of an “optical device”.

The light source unit 111 includes a solid-state light source such as a light emitting diode (LED) or a laser light source.

In the present embodiment, a case in which the light source unit 111 includes the solid-state light source is explained. However, the light source unit 111 is not limited thereto. The light source unit 111 may include a lamp light source such as a halogen lamp, a xenon lamp, or an ultrahigh-pressure mercury lamp instead of the solid-state light source.

The solid-state light source or the lamp light source is sometimes described as light source in the following explanation.

The light source unit 111 may include a reflector and an auxiliary reflector that guide light emitted by the light source to the light modulation device 112. Further, the light source unit 111 may include a lens group for improving an optical characteristic of projection light, a polarizing plate, or a dimming element that reduces, on a path leading to the light modulation device 112, a light amount of the light emitted by the light source.

The light source driver 121 is coupled to an internal bus 107, turns on and off the light source of the light source unit 111 according to an instruction of a first controller 150 also coupled to the internal bus 107, and controls output of the light source. In the present embodiment, the light source driver 121 controls the output of the light source according to an instruction of the first controller 150.

The light modulation device 112 includes, for example, three liquid crystal panels 115 corresponding to the three primary colors of R, G, and B. R represents red, G represents green, and B represents blue. That is, the light modulation device 112 includes a red liquid crystal panel corresponding to R color light, a green liquid crystal panel corresponding to G color light, and a blue liquid crystal panel corresponding to B color light.

Light emitted by the light source of the light source unit 111 is made incident on the liquid crystal panels 115.

Each of the three liquid crystal panels 115 is a transmissive liquid crystal panel and modulates light transmitted therethrough to generate the projection light PL. The projection light PL includes red image light, green image light, and blue image light. The red image light is red image light having passed through the red liquid crystal panel to be modulated. The green image light is green image light having passed through the green liquid crystal panel to be modulated. The blue image light is blue image light having passed through the blue liquid crystal panel to be modulated.

The red image light, the green image light, and the blue image light are combined by a combination optical system such as a cross dichroic prism and the projection light PL is generated. The projection light PL is emitted to the projection optical system 113.

In the present embodiment, a case in which the light modulation device 112 includes the transmissive liquid crystal panels 115 as light modulation elements is explained. However, the light modulation element is not limited thereto. The light modulation elements may be reflective liquid crystal panels or may be digital micromirror devices. The number of light modulation elements may not be three and may be, for example, one.

The light modulation device 112 is driven by the light modulation device driver 122. The light modulation device driver 122 is coupled to an image processor 145.

Image data corresponding to the primary colors of R, G, and B are input to the light modulation device driver 122 from the image processor 145. The light modulation device driver 122 converts the input image data into a data signal suitable for an operation of the liquid crystal panels 115. The light modulation device driver 122 applies a voltage to pixels of the liquid crystal panels 115 based on the data signal, into which the image data has been converted, to draw images on the liquid crystal panel 115.

The projection optical system 113 includes a projection lens 113A, a mirror, and the like that cause the incident projection light PL to form an image on the screen SC. The projection optical system 113 includes a zoom mechanism for enlarging or reducing an image projected onto the screen SC, a focus adjustment mechanism for adjusting a focus, and a lens shift mechanism for adjusting a projection direction of the projection light PL.

The projector 1 further includes an operation unit 131, a remote controller light receiver 133, an input interface 135, a storage 137, a first communication interface 141, a frame memory 143, the image processor 145, and the first controller 150. The input interface 135, the storage 137, the first communication interface 141, the image processor 145, and the first controller 150 are connected to one another via an internal bus 107 to be capable of performing data communication.

The operation unit 131 includes various buttons and switches provided on a housing surface of the projector 1, generates an operation signal corresponding to operation of the buttons and the switches, and outputs the operation signal to the input interface 135. The input interface 135 includes a circuit that outputs the operation signal input from the operation unit 131 to the first controller 150.

The remote controller light receiver 133 receives an infrared signal transmitted from a remote controller 5 and decodes the received infrared signal to generate an operation signal. The remote controller light receiver 133 outputs the generated operation signal to the input interface 135. The input interface 135 includes a circuit that outputs the operation signal input from the remote controller light receiver 133 to the first controller 150. The operation unit 131, the remote controller 5, and the remote controller light receiver 133 can also be referred to as input device.

The storage 137 is, for example, a magnetic recording device such as a hard disk driver (HDD) or a storage device including a semiconductor storage element such as a flash memory or a solid-state drive (SSD). The storage 137 stores a program to be executed by the first controller 150, data processed by the first controller 150, image data, and the like.

The first communication interface 141 is a communication interface that executes communication with the server device 2 according to the Ethernet (registered trademark) standard. The first communication interface 141 includes a connector that couples an Ethernet (registered trademark) cable and an interface circuit that processes a signal transmitted through the connector. The first communication interface 141 is an interface board including the connector and the interface circuit and is coupled to a main board on which a first processor 150A of the first controller 150 and the like are implemented. Alternatively, the connector and the interface circuit configuring the first communication interface 141 are implemented on the main board of the first controller 150. The first communication interface 141 transmits the first information QJ1 to the server device 2 and receives the second information QJ2 from the server device 2.

The first controller 150 includes a first memory 150B and the first processor 150A.

The first memory 150B is a storage device that stores a program to be executed by the first processor 150A and data in a nonvolatile manner. The first memory 150B is configured with a magnetic storage device, a semiconductor storage element such as a flash read only memory (ROM), or a nonvolatile storage device of another type. The first memory 150B may include a random access memory (RAM) configuring a work area of the first processor 150A. The first memory 150B stores data to be processed by the first controller 150, a first control program PG1 to be executed by the first processor 150A, and the like.

The first processor 150A may be configured by a single processor or a plurality of processors may be configured to function as the first processor 150A. The first processor 150A executes the first control program PG1 to control units of the projector 1. For example, the first processor 150A outputs, to the image processor 145, an instruction to execute image processing corresponding to operation received by the operation unit 131 and the remote controller 5 and parameters used for the image processing. The parameters include, for example, a geometric correction parameter for correcting geometric distortion of an image projected onto the screen SC. The first processor 150A controls the light source driver 121 to control lighting and extinction of the light source unit 111 and adjusts output of the light source unit 111, that is, a light amount.

The first processor 150A may be configured by a system-on-a-chip (SoC) integrated with a part or the entire first memory 150B and other circuits. The first processor 150A may be configured by a combination of a central processing unit (CPU) that executes a program and a digital signal processor (DSP) that executes predetermined arithmetic processing. All of functions of the first processor 150A may be configured to be implemented in hardware or may be configured using a programmable device.

The first processor 150A corresponds to an example of “at least one processor”.

The image processor 145 and the frame memory 143 can be configured by, for example, an integrated circuit. The integrated circuit includes a large-scale integration (LSI) circuit, an application specific integrated circuit (ASIC), and a programmable logic device (PLD). The PLD includes, for example, a field-programmable gate array (FPGA). A part of a configuration of the integrated circuit may include an analog circuit or a processor and the integrated circuit may be combined. The combination of the processor and the integrated circuit is called microcontroller (MCU), system-on-a-chip (SoC), system LSI, chip set, or the like.

The image processor 145 is configured by, for example, an integrated circuit. The image processor 145 loads image data input from the first communication interface 141 in the frame memory 143. The frame memory 143 has a plurality of banks. Each of the banks has a storage capacity with which image data for one frame can be written. The frame memory 143 is configured by, for example, a synchronous dynamic random access memory (SDRAM).

The image processor 145 performs image processing such as resolution conversion processing, resize processing, distortion correction, shape correction processing, or digital zooming on the image data loaded in the frame memory 143.

The image processor 145 generates a vertical synchronization signal obtained by converting an input frame frequency of a vertical synchronization signal into a drawing frequency. The generated vertical synchronization signal is referred to as output synchronization signal. The image processor 145 outputs the generated output synchronization signal to the light modulation device driver 122.

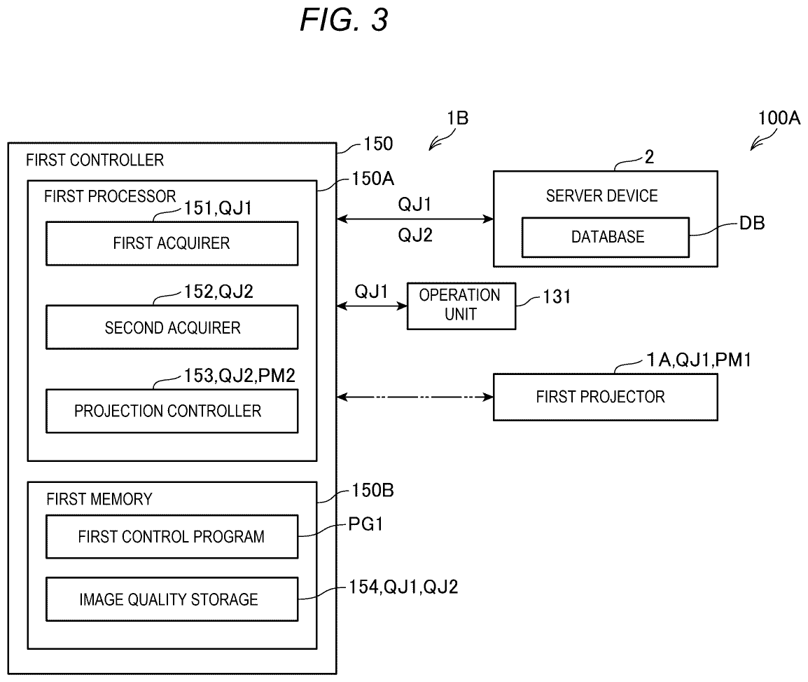

Subsequently, a configuration of the first controller 150 of the second projector 1B according to the first embodiment is explained with reference to FIG. 3. FIG. 3 is a diagram illustrating an example of the configuration of the first controller 150 of the second projector 1B.

In the following explanation, a case in which the first processor 150A executes the first control program PG1 to thereby control the image quality of the projection image PM projected by the second projector 1B is explained.

The first control program PG1 corresponds to an example of an “image quality control program”.

The first controller 150 includes a first acquirer 151, a second acquirer 152, a projection controller 153, and an image quality storage 154.

Specifically, the first processor 150A of the first controller 150 by executes the first control program PG1 stored in the first memory 150B to thereby function as the first acquirer 151, the second acquirer 152, and the projection controller 153. The first processor 150A of the first controller 150 executes the first control program PG1 stored in the first memory 150B to thereby cause the first memory 150B to function as the image quality storage 154.

The image quality storage 154 stores the first information QJ1 and the second information QJ2. The image quality of an image is visual quality of the image. The image quality of the image is represented by, for example, brightness, tint, contrast, and resolution but is not limited thereto.

The first information QJ1 indicates the image quality of a first projection image PM1 projected by the first projector 1A. The first projector 1A displays the first projection image PMI on a first screen SC1 based on the first information QJ1.

The first information QJ1 is information concerning a setting value for controlling the image quality of the first projector 1A. The first information QJ1 may be represented by one or a plurality of setting values, may be information indirectly representing image quality like information of a mode concerning image quality, or may be a combination thereof. The first information QJ1 may include a setting value preset for the first projector 1A or may include a setting value set by the user.

In the present embodiment, the first information QJ1 includes information indicating a first image quality mode QM1 for controlling the image quality of the first projector 1A. The first image quality mode QM1 is defined by a plurality of setting values preset in the first projector 1A. By using the information indicating the first image quality mode QM1 as the first information QJ1, a data structure of the database DB explained below can be simplified compared with a case in which the first information QJ1 is represented by a plurality of setting values. In the present embodiment, since the first image quality mode QM1 is defined by the preset setting values, combinations of setting values to be assumed in the database DB are fewer compared with a case in which the user can change the setting values. Therefore, the data structure of the database DB can be simplified.

The second information QJ2 indicates the image quality of a second projection image PM2 projected by the second projector 1B. The second information QJ2 indicates image quality corresponding to the first information QJ1 in the second projection image PM2 projected by the second projector 1B. The second projector 1B displays the second projection image PM2 on a second screen SC2 based on the second information QJ2. The second information QJ2 includes information indicating a second image quality mode QM2 for controlling the image quality of the second projector 1B. The second image quality mode QM2 is defined by a plurality of setting values preset in the second projector 1B.

The first projection image PM1 corresponds to an example of the projection image PM. The second projection image PM2 corresponds to an example of the projection image PM. The second projection image PM2 may be the same image as the first projection image PM1 or may be an image different from the first projection image PM1.

The first projection image PM1 corresponds to an example of a “first image”.

The second projection image PM2 corresponds to an example of a “second image”.

The first screen SC1 corresponds to an example of the screen SC. The second screen SC2 corresponds to an example of the screen SC. The second screen SC2 may be the same screen SC as the first screen SC1 or may be a screen SC different from the first screen SC1.

In other words, the first projector 1A and the second projector 1B may perform so-called “stacking” projection for superimposing the same images and projecting the images at the same position or may perform so-called “tiling” projection for projecting one image as a whole by connecting two images. The first projector 1A and the second projector 1B may project images different from each other on the screens SC different from each other. For example, the present disclosure is particularly suitably used in a use environment in which both the first projection image PM1 and the second projection image PM2 are visually recognized by the user, such as the same space.

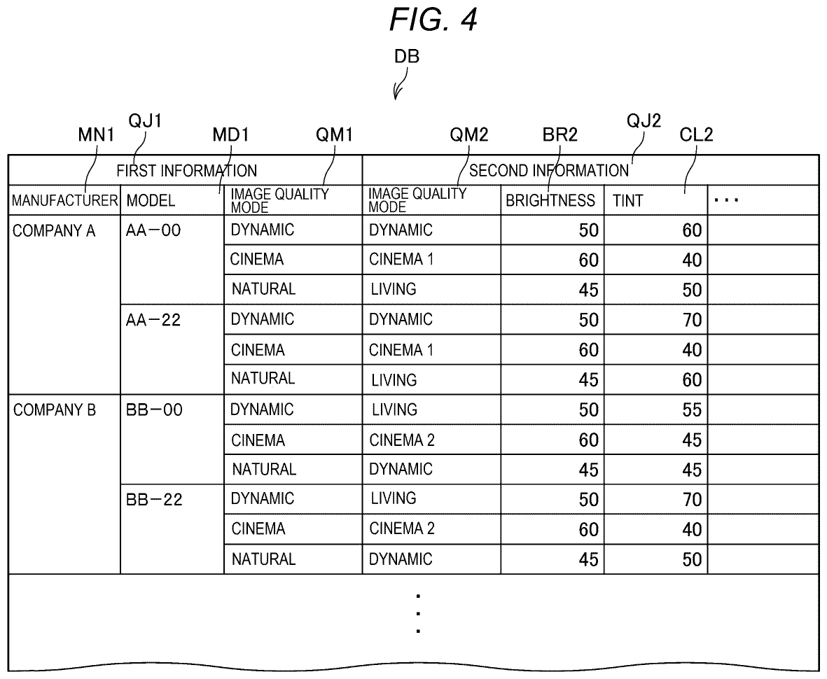

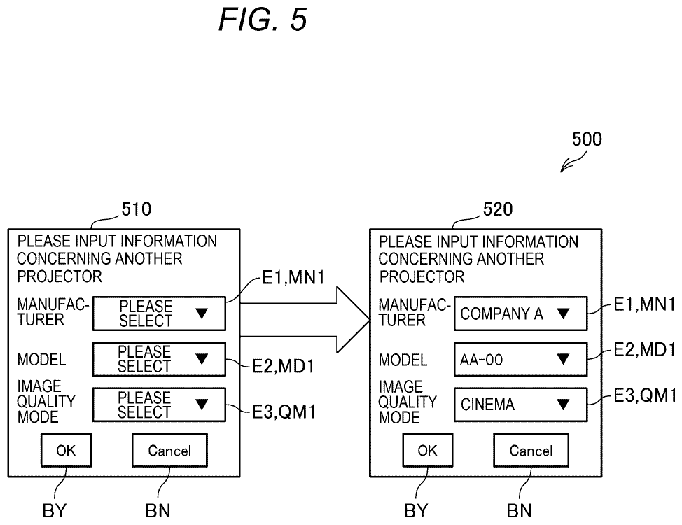

The first information QJ1 and the second information QJ2 are further explained with reference to FIG. 4.

The first information QJ1 is acquired by the first acquirer 151 and stored in the image quality storage 154 by the first acquirer 151. The second information QJ2 is acquired by the second acquirer 152 and stored in the image quality storage 154 by the second acquirer 152.

The first acquirer 151 acquires the first information QJ1 based on operation of the user. The first acquirer 151 acquires the first information QJ1 based on, for example, operation of the user on the operation unit 131. The first acquirer 151 stores the acquired first information QJ1 in the image quality storage 154.

Processing of the first acquirer 151 is further explained with reference to FIG. 5.

The second acquirer 152 acquires the second information QJ2 from the database DB of the server device 2. First, the second acquirer 152 transmits the first information QJ1 to, for example, the server device 2. Subsequently, the server device 2 reads the second information QJ2 corresponding to the first information QJ1 from the database DB. Subsequently, the server device 2 transmits the read second information QJ2 to the second projector 1B. Subsequently, the second acquirer 152 acquires the second information QJ2 by receiving the second information QJ2 from the server device 2. The second acquirer 152 causes the image quality storage 154 to store the acquired second information QJ2.

The server device 2 is configured to, when receiving the first information QJ1 from the second projector 1B, read the second information QJ2 corresponding to the first information QJ1 from the database DB and transmit the second information QJ2 to the second projector 1B.

The projection controller 153 sets the second information QJ2 in the second projector 1B. That is, the projection controller 153 applies a setting value corresponding to the second information QJ2 to the second projector 1B as a setting value used for projection. The projection controller 153 causes the second projector 1B to project the projection light PL corresponding to the second projection image PM2 onto the second screen SC2 and causes the second screen SC2 to display the second projection image PM2.

Subsequently, a configuration of the database DB is explained with reference to FIG. 4. FIG. 4 is a table illustrating an example of the configuration of the database DB.

In FIG. 4, the first information QJ1 and the second information QJ2 are described in association with each other in a table format. As illustrated in FIG. 4, the first information QJ1 includes first manufacturer information MN1 indicating a manufacturer of the first projector 1A, first model information MD1 indicating a model of the first projector 1A, and a first image quality mode QM1.

The first manufacturer information MN1 corresponds to an example of “manufacturer information”.

The first model information MD1 corresponds to an example of “model information”.

The first manufacturer information MN1 includes, for example, a “company A” and a “company B”. When the first manufacturer information MN1 is, for example, the “company A”, the first model information MD1 includes “AA-00” and “AA-22”. When the first model information MD1 is the “AA-00”, the first image quality mode QM1 includes a “dynamic mode”, a “cinema mode”, and a “natural mode”.

When the first manufacturer information MN1 is the “company A”, the first model information MD1 is the “AA-00”, and the first image quality mode QM1 is the “dynamic mode”, the second image quality mode QM2 of the second information QJ2 corresponding to the first image quality mode QM1 is the “dynamic mode”.

When the first manufacturer information MN1 is the “company A”, the first model information MD1 is the “AA-00”, and the first image quality mode QM1 is the “cinema mode”, the second image quality mode QM2 of the second information QJ2 corresponding to the first image quality mode QM1 is the “cinema 1 mode”.

When the first manufacturer information MN1 is the “company A”, the first model information MD1 is the “AA-00”, and the first image quality mode QM1 is the “natural mode”, the second image quality mode QM2 of the second information QJ2 corresponding to the first image quality mode QM1 is a “living mode”.

The second image quality mode QM2 defines brightness BR2, tint CL2, and the like of the second projection image PM2. When the second image quality mode QM2 is the “dynamic mode”, the brightness BR2 of the second projection image PM2 is set to “50” and the tint CL2 of the second projection image PM2 is set to “60”. When the second image quality mode QM2 is a “cinema 1 mode”, the brightness BR2 of the second projection image PM2 is set to “60” and the tint CL2 of the second projection image PM2 is set to “40”. When the second image quality mode QM2 is the “living mode”, the brightness BR2 of the second projection image PM2 is set to “45”, and the tint CL2 of the second projection image PM2 is set to “50”.

A setting value of the second image quality mode QM2 may be a value preset in the second projector 1B or may be a value defined in the database DB and different from the preset value. If the setting value is the preset value, the description of the setting value can be omitted in the database DB. Therefore, the database DB can be simplified. When the value different from the preset is included, the image quality of the second projection image PM2 can be set closer to the image quality of the first projection image PM1.

The brightness BR2 and the tint CL2 correspond to an example of a “plurality of setting values”.

Subsequently, processing of the first acquirer 151 is further explained with reference to FIG. 5. FIG. 5 is a screen diagram illustrating an example of an input screen 500 of the user. The input screen 500 is projected, for example, from the second projector 1B onto the second screen SC2 by the first acquirer 151. The user operates, for example, the remote controller 5 or the operation unit 131 of the second projector 1B to perform input operation to the input screen 500. The input screen 500 may be displayed, by the first acquirer 151, on a liquid crystal display (LCD) disposed on a touch panel of the operation unit 131.

FIG. 5 illustrates a first input screen 510 and a second input screen 520 after input to items of the first input screen 510 by operation of the user. The first input screen 510 and the second input screen 520 correspond to an example of the input screen 500. The first input screen 510 is the input screen 500 before reception of operation of the user. The user checks product information described on a main body of the first projector 1A and a menu screen of the first projector 1A to thereby input the items of the input screen 500.

Each of the first input screen 510 and the second input screen 520 includes a first input section E1, a second input section E2, a third input section E3, an OK button BY, and a cancel button BN.

The first input section E1 receives the first manufacturer information MN1 based on operation of the user. When touch operation on a field of “Please select. □” displayed in the first input section E1 of the first input screen 510 is received, the first acquirer 151 displays a list of the first manufacturer information MN1 as a pull-down menu. When touch operation for selecting one piece of the first manufacturer information MN1 from the displayed list of the first manufacturer information MN1 is received, the first acquirer 151 displays the selected first manufacturer information MN1.

The second input section E2 receives the first model information MD1 based on operation of the user. When touch operation on a field of “Please select. □” displayed in the second input section E2 of the first input screen 510 is received, the first acquirer 151 displays a list of the first model information MD1 as a pull-down menu. The list of the first model information MD1 is a list of the first model information MD1 concerning models manufactured by a manufacturer indicated by the first manufacturer information MN1 selected in the first input section E1. When touch operation for selecting one piece of the first model information MD1 from the displayed list of the first model information MD1 is received, the first acquirer 151 displays the selected first model information MD1.

The third input section E3 receives the first image quality mode QM1 based on operation of the user. When touch operation on a field of “Please select. □” displayed in the third input section E3 of the first input screen 510 is received, the first acquirer 151 displays the list of the first image quality mode QM1 as a pull-down menu. The list of the first image quality modes QM1 is a list of the plurality of first image quality modes QM1 included in the first model information MD1 selected in the second input section E2. When touch operation for selecting one first image quality mode QM1 from the displayed list of the plurality of first image quality modes QM1 is received, the first acquirer 151 displays the selected first image quality mode QM1.

When the first image quality mode QM1 is limited to a mode defined by a preset setting value, the third input section E3 preferably does not display, as a choice, an image quality mode in which the user can change the setting value. Accordingly, for example, even when the first projector 1A has an image quality mode in which the user can change a value of a setting value, like a “user setting” mode, it is possible to inform the user that an image quality mode of the first projector 1A needs to be set to the mode defined by the preset setting value.

The plurality of first image quality modes QM1 correspond to an example of “a plurality of candidates for the first information”.

As explained above, the first acquirer 151 receives the first image quality mode QM1 by receiving operation for selecting the first manufacturer information MN1, the first model information MD1, and the first image quality mode QM1 in order. Then, the first acquirer 151 projects the second input screen 520 illustrated in FIG. 5 onto the second screen SC2 via, for example, the second projector 1B. The user operates, for example, the remote controller 5 or the operation unit 131 of the second projector 1B to perform input operation to the input screen 500. The first acquirer 151 may display the input screen 500 on an LCD disposed on the touch panel of the operation unit 131.

On the second input screen 520, for example, the “company A” is displayed in the first input section E1, the “AA-00” is displayed in the second input section E2, and a “cinema” is displayed in the third input section E3.

The second input screen 520 indicates that the following selection operation has been received. First, the “company A” has been selected from the list of the first manufacturer information MN1 displayed in the first input section E1 of the first input screen 510. Subsequently, the “AA-00” has been selected from the list of the first model information MD1 displayed in the second input section E2 of the first input screen 510. Subsequently, the “cinema” has been selected from the list of the first image quality modes QM1 displayed in the third input section E3 of the first input screen 510.

The OK button BY is a button that is touched when the selection operation of the user is determined. The cancel button BN is a button that is touched when the selection operation of the user is canceled.

As explained above, by inputting the selection operation on the first input screen 510, the user can easily select the first image quality mode QM1 as shown on the second input screen 520.

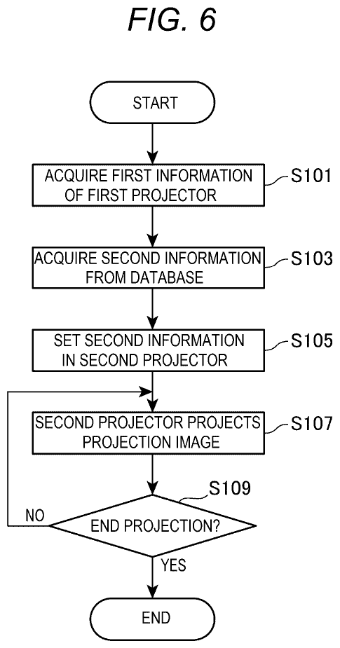

Subsequently, processing of the first controller 150 of the second projector 1B is explained with reference to FIG. 6. FIG. 6 is a flowchart illustrating an example of the processing of the first controller 150 of the second projector 1B.

As illustrated in FIG. 6, in step S101, the first acquirer 151 acquires the first information QJ1 based on operation of the user.

Subsequently, in step S103, the second acquirer 152 acquires the second information QJ2 from the database DB. First, the second acquirer 152 transmits the first information QJ1 to, for example, the server device 2. Subsequently, the server device 2 reads the second information QJ2 corresponding to the first information QJ1 from the database DB. Subsequently, the server device 2 transmits the read second information QJ2 to the second projector 1B. Subsequently, the second acquirer 152 acquires the second information QJ2 from the server device 2.

Subsequently, in step S105, the projection controller 153 sets the second information QJ2 in the second projector 1B.

Subsequently, in step S107, the projection controller 153 causes the second projector 1B to project the projection light PL corresponding to the second projection image PM2 onto the second screen SC2 and causes the second screen SC2 to display the second projection image PM2.

Subsequently, in step S109, the first controller 150 determines whether to end the projection of the second projector 1B.

When the first controller 150 determines not to end the projection of the second projector 1B (NO in step S109), the processing returns to step S107. When the first controller 150 determines to end the projection of the second projector 1B (YES in step S109), the processing ends thereafter.

### 2. Second Embodiment

Subsequently, the image quality control system 100B according to the second embodiment is explained mainly with reference to FIGS. 7 to 9. In the following explanation, differences of the image quality control system 100B according to the second embodiment from the image quality control system 100A according to the first embodiment are mainly explained. The same components as those of the image quality control system 100A according to the first embodiment are denoted by the same reference numerals and signs as those in the first embodiment and explanation of the components is omitted.

First, a configuration of the image quality control system 100B according to the second embodiment is explained with reference to FIG. 7. FIG. 7 is a diagram illustrating an example of the configuration of the image quality control system 100B according to the second embodiment.

As illustrated in FIG. 7, the image quality control system 100B is different from the image quality control system 100A according to the first embodiment in that the image quality control system 100B includes a smartphone 3A.

The smartphone 3A is communicably connected to the server device 2 via the network NW. The smartphone 3A is communicably connected to the second projector 1B via wireless communication such as Wi-Fi (registered trademark).

The smartphone 3A acquires the first information QJ1 based on operation of a user. The smartphone 3A acquires the second information QJ2 corresponding to the first information QJ1 from the server device 2. The smartphone 3A causes the second projector 1B to project the projection image PM corresponding to the second information QJ2.

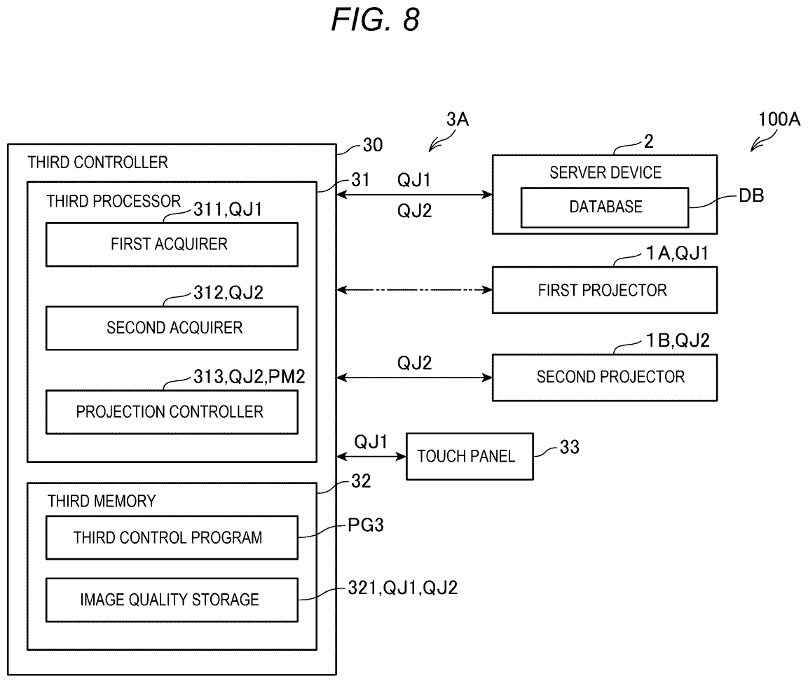

In other words, the smartphone 3A has the functions of the first controller 150 of the second projector 1B in the image quality control system 100A according to the first embodiment. The functions of the smartphone 3A are further explained with reference to FIG. 8.

A configuration of each of the first projector 1A and the second projector 1B is the same as the configuration of the projector 1 explained with reference to FIG. 2.

Subsequently, a configuration of the smartphone 3A is explained with reference to FIG. 8. FIG. 8 is a diagram illustrating an example of a configuration of a third controller 30 of the smartphone 3A.

As illustrated in FIG. 8, the smartphone 3A includes the third controller 30 and a touch panel 33.

The third controller 30 includes a third processor 31 and a third memory 32.

The third memory 32 is a storage device that stores a program to be executed by the third processor 31 and data in a nonvolatile manner. The third memory 32 is configured by a magnetic storage device, a semiconductor storage element such as a flash ROM, or a nonvolatile storage device of another type. The third memory 32 may include a RAM configuring a work area of the third processor 31. The third memory 32 stores data to be processed by the third controller 30, a third control program PG3 to be executed by the third processor 31, and the like.

The third processor 31 may be configured by a single processor or a plurality of processors may be configured to function as the third processor 31. The third processor 31 executes a first control program to control the units of the smartphone 3A. For example, the third processor 31 causes the units of the smartphone 3A to execute processing corresponding to operation received by the touch panel 33.

The third processor 31 may be configured by an SoC integrated with a part or the entire third memory 32 and other circuits. The third processor 31 may be configured by a combination of a CPU that executes a program and a DSP that executes predetermined arithmetic processing. All of the functions of the third processor 31 may be configured to be implemented in hardware or may be configured using a programmable device.

The touch panel 33 includes a display such as an LCD and a touch sensor. The touch sensor is disposed, for example, on the surface of the LCD and receives touch operation of the user. The touch sensor outputs a signal indicating the received touch operation to the third controller 30.

The third controller 30 includes a first acquirer 311, a second acquirer 312, a projection controller 313, and an image quality storage 321.

Specifically, the third processor 31 of the third controller 30 executes the third control program PG3 stored in the third memory 32 to thereby function as the first acquirer 311, the second acquirer 312, and the projection controller 313. The third processor 31 of the third controller 30 executes the third control program PG3 stored in the third memory 32 to thereby cause the third memory 32 to function as the image quality storage 321.

The third processor 31 corresponds to an example of a “processor”.

The third control program PG3 corresponds to an example of an “image quality control program”.

The image quality storage 321 stores the first information QJ1 and the second information QJ2.

The first information QJ1 is acquired by the first acquirer 311 and stored in the image quality storage 321 by the first acquirer 311. The second information QJ2 is acquired by the second acquirer 312 and stored in the image quality storage 321 by the second acquirer 312.

The first t acquirer 311 acquires the first information QJ1 based on operation of the user. The first acquirer 311 acquires the first information QJ1 based on, for example, operation of the user on the touch panel 33. The first acquirer 311 stores causes the image quality storage 321 to store the acquired first information QJ1.

For example, as explained with reference to FIG. 5, the first acquirer 311 displays the first input screen 510 on the touch panel 33. The first acquirer 311 receives operation on the first input section E1, the second input section E2, and the third input section E3 of the first input screen 510 and receives the first manufacturer information MN1, the first model information MD1, and the first image quality mode QM1.

The first acquirer 311 displays the second input screen 520 on the touch panel 33.

The second acquirer 312 acquires the second information QJ2 from the database DB of the server device 2. The database DB has the configuration explained with reference to FIG. 4.

First, for example, the second acquirer 312 transmits the first information QJ1 to the server device 2. Subsequently, the server device 2 reads the second information QJ2 corresponding to the first information QJ1 from the database DB. Subsequently, the server device 2 transmits the read second information QJ2 to the smartphone 3. Subsequently, the second acquirer 312 acquires the second information QJ2 by receiving the second information QJ2 from the server device 2. The second acquirer 312 causes the image quality storage 321 to store the acquired second information QJ2.

The server device 2 is configured to, when receiving the first information QJ1 from the smartphone 3, read the second information QJ2 corresponding to the first information QJ1 from the database DB and transmit the second information QJ2 to the smartphone 3.

The projection controller 313 sets the second information QJ2 in the second projector 1B. For example, first, the projection controller 313 transmits the second information QJ2 to the second projector 1B.

The second projector 1B includes a second communication interface not illustrated in FIG. 2. The second communication interface is a communication interface that executes communication with the smartphone 3A according to the Wi-Fi (registered trademark) standard.

The second communication interface of the second projector 1B receives the second information QJ2. Then, the first controller 150 of the second projector 1B acquires the second information QJ2. Subsequently, the first controller 150 of the second projector 1B sets the second information QJ2.

The projection controller 313 causes the second projector 1B to project the projection light PL corresponding to the second projection image PM2 onto the second screen SC2 and causes the second screen SC2 to display the second projection image PM2.

Processing of the third controller 30 of the smartphone 3A in the image quality control system 100B according to the second embodiment is substantially the same as the processing of the first controller 150 of the second projector 1B explained with reference to FIG. 6 in the image quality control system 100A according to the first embodiment.

Specifically, the first acquirer 311 of the third controller 30 of the smartphone 3A executes the processing of the first acquirer 151 of the first controller 150 of the second projector 1B in step S101 in FIG. 6. The second acquirer 312 of the third controller 30 of the smartphone 3A executes the processing of the second acquirer 152 of the first controller 150 of the second projector 1B in step S103 in FIG. 6. The projection controller 313 of the third controller 30 of the smartphone 3A executes the processing of the projection controller 153 of the first controller 150 of the second projector 1B in the steps S105 and S107 in FIG. 6. The third controller 30 of the smartphone 3A executes the processing of the first controller 150 of the second projector 1B in step S109 in FIG. 6.

### 3. Modification of the Second Embodiment

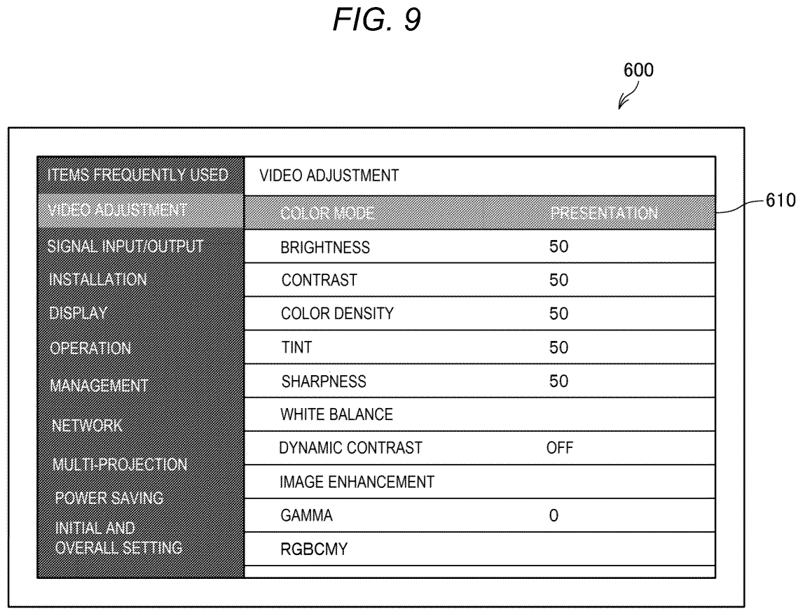

Subsequently, a modification of the image quality control system 100B according to the second embodiment is explained with reference to FIG. 9. FIG. 9 is a screen diagram illustrating an example of a display screen 600 of the first projector 1A.

In the following explanation, differences of the modification of the image quality control system 100B according to the second embodiment from the image quality control system 100B according to the second embodiment are mainly explained. The same components as those of the image quality control system 100B according to the second embodiment are denoted by the same reference numerals and signs as those in the second embodiment and explanation of the components is omitted.

As explained with reference to FIG. 8, in the image quality control system 100B according to the second embodiment, the first acquirer 311 displays the first input screen 510 on the touch panel 33, for example, as explained with reference to FIG. 5. The first acquirer 311 receives operation on the first input section E1, the second input section E2, and the third input section E3 of the first input screen 510 and receives the first manufacturer information MN1, the first model information MD1, and the first image quality mode QM1.

In contrast, in the modification of the image quality control system 100B according to the second embodiment, the first acquirer 311 receives the first manufacturer information MN1, the first model information MD1, and the first image quality mode QM1, for example, based on a captured image of the display screen 600 of the first projector 1A.

The display screen 600 shows, for example, a menu screen of the first projector 1A.

As illustrated in FIG. 9, the display screen 600 includes an image quality mode display 610. In the image quality mode display 610, for example, a “presentation mode” is set as the first image quality mode QM1.

That is, first, the user causes the LCD of the operation unit 131 of the first projector 1A to display a menu screen. Then, the first acquirer 311 causes a not-illustrated camera provided in the smartphone 3A to capture an image of the menu screen and acquires a captured image of the display screen 600. The first acquirer 311 applies character recognition processing to the captured image of the display screen 600 and receives the first image quality mode QM1 being the “presentation mode”. As explained above, the first acquirer 311 receives the first image quality mode QM1 based on the captured image of the display screen 600 of the first projector 1A.

In FIG. 9, a case in which the first acquirer 311 receives the first image quality mode QM1 based on the captured image of the display screen 600 of the first projector 1A is explained. However, similarly, the first acquirer 311 acquires the first manufacturer information MN1 and the first model information MD1 based on the captured image of the first projector 1A.

The first acquirer 311 causes, for example, a not-illustrated camera provided in the smartphone 3A to capture an image of a model number display panel disposed on the back surface or the like of the main body of the first projector 1A and acquire a captured image of the model number display panel. The first acquirer 311 applies character recognition processing to the captured image of the model number display panel and acquires the first manufacturer information MN1 and the first model information MD1 of the first projector 1A.

As explained above, the first acquirer 311 receives the first manufacturer information MN1, the first model information MD1, and the first image quality mode QM1 based on the captured image of the first projector 1A. Therefore, compared with the image quality control system 100B according to the second embodiment, a load on the user in acquiring the first manufacturer information MN1, the first model information MD1, and the first image quality mode QM1 can be reduced.

### 4. Third Embodiment

Subsequently, the image quality control system 100C according to the third embodiment is explained mainly with reference to FIGS. 10 and 11. In the following explanation, differences of the image quality control system 100C according to the third embodiment from the image quality control system 100B according to the second embodiment are mainly explained. The same components as those of the image quality control system 100B according to the second embodiment are denoted by the same reference numerals and signs as those in the second embodiment and explanation of the components is omitted.

First, a configuration of an image quality control system 100C according to the third embodiment is explained with reference to FIG. 10. FIG. 10 is a diagram illustrating an example of the configuration of the image quality control system 100C according to the third embodiment.

As illustrated in FIG. 10, the image quality control system 100C is different from the image quality control system 100B according to the second embodiment in that a smartphone 3B includes the database DB. Since the smartphone 3B includes the database DB, the image quality control system 100C does not need to communicate with the server device 2 each time. In other words, the image quality control system 100C may not include the server device 2.

The smartphone 3B is communicably connected to the second projector 1B via wireless communication such as Wi-Fi (registered trademark).

The smartphone 3B acquires the first information QJ1 based on operation of a user. The smartphone 3A acquires the second information QJ2 corresponding to the first information QJ1 from the database DB. The smartphone 3A causes the second projector 1B to project the projection image PM corresponding to the second information QJ2.

Subsequently, a configuration of the smartphone 3B is explained with reference to FIG. 11. FIG. 11 is a diagram illustrating an example of a configuration of the third controller 30 of the smartphone 3B.

As illustrated in FIG. 11, the smartphone 3B includes the third controller 30 and the touch panel 33.

The third controller 30 includes the first acquirer 311, the second acquirer 312, the projection controller 313, the image quality storage 321, and the database DB.

Specifically, the third processor 31 of the third controller 30 executes a fourth control program PG4 stored in the third memory 32 to thereby function as the first acquirer 311, the second acquirer 312, and the projection controller 313. The third processor 31 of the third controller 30 executes the fourth control program PG4 stored in the third memory 32 to thereby cause the third memory 32 to function as the image quality storage 321 and the database DB.

The third processor 31 corresponds to an example of a “processor”.

The fourth control program PG4 corresponds to an example of a “image quality control program”.

The image quality storage 321 stores the first information QJ1 and the second information QJ2.

The database DB stores the first information QJ1 and the second information QJ2 in association with each other. The database DB has the configuration explained with reference to FIG. 4.

Functions of the first acquirer 311 are the same as the functions of the first acquirer 311 of the smartphone 3A of the image quality control system 100B according to the second embodiment explained with reference to FIG. 8.

Functions of the projection controller 313 are the same as the functions of the projection controller 313 of the smartphone 3A of the image quality control system 100B according to the second embodiment explained with reference to FIG. 8.

The second acquirer 312 acquires the second information QJ2 from the database DB.

First, the second acquirer 312 acquires the second information QJ2 by, for example, reading, from the database DB, the second information QJ2 corresponding to the first information QJ1 acquired by the first acquirer 311. The second acquirer 312 causes the image quality storage 321 to store the acquired second information QJ2.

Processing of the third controller 30 of the smartphone 3B in the image quality control system 100C according to the third embodiment is substantially the same as the processing of the third controller 30 of the smartphone 3A explained with reference to FIG. 6 in the image quality control system 100B according to the second embodiment.

However, since processing corresponding to step S103 in FIG. 6 is different, the processing is explained below.

In step S103 in FIG. 6, the second acquirer 152 acquires the second information QJ2 from the database DB. For example, the second acquirer 152 acquires the second information QJ2 by reading, from the database DB, the second information QJ2 corresponding to the first information QJ1 acquired by the first acquirer 311.

As explained with reference to FIGS. 10 and 11, in the image quality control system 100C according to the third embodiment, since the smartphone 3B includes the database DB, the second acquirer 152 can acquire the second information QJ2 corresponding to the first information QJ1 with simple processing.

### 5. Present Embodiment and Action Effects

As explained above with reference to FIGS. 1 to 11, the image quality control method includes acquiring the first information QJ1 indicating the image quality of the first projector 1A, acquiring the second information QJ2 indicating the image quality, which corresponds to the first information QJ1, of the second projector 1B different from the first projector 1A from the database DB that stores the first information QJ1 and the second information QJ2 in association with each other, and setting the second information QJ2 in the second projector 1B.

Therefore, since the second information QJ2 indicating the image quality of the second projector 1B corresponding to the image quality of the first projector 1A is set in the second projector 1B, the image quality of the second projector 1B can be set to image quality approximate to the image quality of the first projector 1A.

The image quality control method further includes the first projector 1A displaying the first projection image PM1 based on the first information QJ1 and the second projector 1B displaying the second projection image PM2 based on the second information QJ2.

Therefore, the second projection image PM2 projected by the second projector 1B can be displayed with image quality approximate to the image quality of the first projection image PMI projected by the first projector 1A.

In the image quality control method, the first information QJ1 includes the information indicating the first image quality mode QM1 for controlling the image quality of the first projector 1A.

Therefore, by causing the first projector 1A to perform projection in the first image quality mode QM1, it is possible to cause the first projector 1A to perform projection with the image quality indicated by the first information QJ1. It is possible to simplify the database DB indicating the correspondence relationship with the second information QJ2 compared with a case in which the first information QJ1 is expressed by the plurality of setting values indicating the image quality of the first projector 1A.

In the image quality control method, the first image quality mode QM1 is defined by the plurality of setting values preset in the first projector 1A.

Therefore, by defining setting values defining image quality such as brightness and tint as the plurality of setting values, it is possible to cause the first projector 1A to perform projection with the image quality indicated by the first image quality mode QM1.

In the image quality control method, the acquiring the first information QJ1 includes acquiring the first information QJ1 based on the captured image obtained by capturing the image including the first information QJ1 displayed by the first projector 1A.

Therefore, since the first information QJ1 is acquired based on the captured image obtained by capturing the image including the first information QJ1 displayed by the first projector 1A, the first information QJ1 can be more easily acquired compared with a case in which the user manually inputs the first information QJ1.

In the image quality control method, the acquiring the first information QJ1 includes acquiring the first information QJ1 based on operation of the user.

Therefore, since the first information QJ1 is acquired based on the operation of the user, the first information QJ1 can be acquired with a simple configuration.

In the image quality control method, the acquiring the first information QJ1 includes acquiring the first manufacturer information MN1 and the first model information MD1 of the first projector 1A based on operation of the user, selectably displaying the plurality of first image quality modes QM1 based on the first manufacturer information MN1 and the first model information MD1, and acquiring the first image quality mode QM1 out of the plurality of first image quality modes QM1 based on operation of the user.

Therefore, since the first image quality mode QM1 of the first projector 1A is acquired based on operation of the user for the selectably displayed plurality of first image quality modes QM1, the first information QJ1 can be easily acquired with a simple configuration.

In the image quality control method, the first information QJ1 includes the first model information MD1 indicating the model of the first projector 1A.

Therefore, in order to acquire the first model information MD1, it is possible to acquire the first information QJ1 of the first projector 1A by selecting one piece of the first information QJ1 from a plurality of pieces of first information QJ1 executable by the model indicated by the first model information MD1.

The first control program PG1 according to the present embodiment includes the first processor 150A acquiring the first information QJ1 indicating the image quality of the first projector 1A, acquiring the second information QJ2 indicating the image quality, which corresponds to the first information QJ1, of the second projector 1B different from the first projector 1A from the database DB that stores the first information QJ1 and the second information QJ2 in association with each other, and setting the second information QJ2 in the second projector 1B.

Therefore, since the first control program PG1 according to the present embodiment has the same configuration as the configuration of the image quality control method for the projector 1 according to the present embodiment, the first control program PG1 achieves the same action effects as those of the image quality control method for the projector 1 according to the present embodiment.

The second projector 1B according to the present embodiment includes the projection unit 110 that projects a projection image, and the first processor 150A that executes acquiring the first information QJ1 representing the image quality of the first projection image PM1 of the first projector 1A, acquiring the second information QJ2 representing the image quality, which corresponds to the first information QJ1, of the second projector 1B different from the first projector 1A from the database DB that stores the first information QJ1 and the second information QJ2 in association with each other, and the second projector 1B projecting the second projection image PM2 with the image quality corresponding to the second information QJ2.

Therefore, with the second information QJ2 indicating the image quality of the second projector 1B corresponding to the image quality of the first projector 1A, the second projection image PM2 projected by the second projector 1B can be projected with image quality approximate to the image quality of the first projection image PM1 projected by the first projector 1A.

### 6. Other Embodiments

The present embodiments explained above are preferred embodiment. The present disclosure is, however, not limited to the present embodiments explained above, and various modified implementations are possible without departing from the gist of the present disclosure.

In the present embodiment, a case in which each of the “first display device” and the “second display device” is the projector 1 is explained. However, the embodiments are not limited thereto. Each of the “first display device” and the “second display device” may be, for example, a display such as an LCD.

In the image quality control system 100B according to the second embodiment and the image quality control system 100C according to the third embodiment, a case in which the smartphone 3 includes the first acquirer 311, the second acquirer 312, and the projection controller 313 is explained. However, the embodiments are not limited thereto. A so-called information processing device only has to include the first acquirer 311, the second acquirer 312, and the projection controller 313. The information processing device may be, for example, a personal computer or may be, for example, a tablet computer.

The functional units illustrated in FIGS. 2, 3, 8, and 11 indicate the functional components and specific implementation forms of the functional units are not particularly limited. That is, hardware individually corresponding to the functional units does not always need to be implemented. One processor can also be configured to implement functions of a plurality of functional units by executing a program. Some of functions implemented by software in the embodiments explained above may be implemented by hardware or some of the functions implemented by hardware in the embodiments explained above may be implemented by software. Besides, the specific detailed configurations of the units of the projector 1 and the smartphone 3 can be optionally changed without departing from the gist.

The processing units of the flowchart illustrated in FIG. 6 are divided according to the main processing contents in order to facilitate understanding of the processing of the first controller 150 of the second projector 1B. The processing units of the flowchart illustrated in FIG. 6 are not limited by a way of division and names of the processing units can also be divided into a larger number of processing units according to processing contents and can also be divided such that one processing units includes a larger number of kinds of processing. The processing order of the flowchart explained above is not limited to the illustrated example.

The image quality control method for the projector 1 can be implemented by causing the first processor 150A of the first controller 150 of the second projector 1B to execute the first control program PG1 corresponding to an image projection method for the projector 1. The image quality control method for the projector 1 can be implemented by causing the third processor 31 of the third controller 30 of the smartphone 3 to execute the third control program PG3 or the fourth control program PG4 corresponding to the image projection method for the projector 1.

Each of the first control program PG1, the third control program PG3, and the fourth control program PG4 can also be recorded in a computer-readable recording medium.

As the recording medium, a magnetic or optical recording medium or a semiconductor memory device can be used. Specific examples of the recording medium include portable and stationary recording media such as a flexible disc, an HDD, a CD-ROM (compact disk read only memory), a DVD, a Blu-ray (trademark registered) Disc, a magneto-optical disc, a flash memory, and a card type recording medium. The recording medium may be a nonvolatile storage device such as a RAM, a ROM, or an HDD, which is an internal storage device, provided in the second projector 1B or the smartphone 3.

The image projection method for the projector 1 can also be implemented by causing a server device or the like to store the first control program PG1 and downloading the first control program PG1 from the server device to the second projector 1B.

The image projection method for the projector 1 can also be implemented by causing a server device or the like to store the third control program PG3 or the fourth control program PG4 and downloading the third control program PG3 or the fourth control program PG4 from the server device to the smartphone 3.

### APPENDICES

A summary of the present disclosure is appended below.

(Appendix 1) An image quality control method including: acquiring first information indicating image quality of a first display device; acquiring second information indicating image quality, which corresponds to the first information, of a second display device different from the first display device from a database that stores the first information and the second information in association with each other; and setting the second information in the second display device.

Accordingly, since the second information indicating the image quality of the second display device corresponding to the image quality of the first display device is set in the second display device, the image quality of the second display device can be set to image quality approximate to the image quality of the first display device.

(Appendix 2) The image quality control method described in the appendix 1, further including: the first display device displaying a first image based on the first information; and the second display device displaying a second image based on the second information.

Accordingly, the second image displayed by the second display device can be displayed with image quality approximate to the image quality of the first image displayed by the first display device.

(Appendix 3) The image quality control method described in the appendix 1 or 2, wherein the first information includes information indicating a first image quality mode for controlling image quality of the first display device.

Accordingly, by displaying the first display device in the first image quality mode, the first display device can display the first image with the image quality indicated by the first information.

(Appendix 4) The image quality control method described in the appendix 3, wherein the first image quality mode is defined by a plurality of setting values preset in the first display device.

Accordingly, the first display device can be displayed with the image quality indicated by the first image quality mode by defining setting values that define image quality such as brightness and tint as the plurality of setting values.

(Appendix 5) The image quality control method described in any one of the appendices 1 to 4, wherein the acquiring the first information includes acquiring the first information based on a captured image obtained by capturing an image including the first information displayed by the first display device.

Accordingly, since the first information is acquired based on the captured image obtained by capturing the image including the first information, the first information can be easily acquired.

(Appendix 6) The image quality control method described in any one of the appendices 1 to 4, wherein the acquiring the first information includes acquiring the first information based on operation of a user.

Accordingly, since the first information is acquired based on the operation of the user, the first information can be acquired with a simple configuration.

(Appendix 7) The image quality control method described in the appendix 6, wherein the acquiring the first information includes: acquiring manufacturer information and model information of the first display device based on the operation of the user; selectably displaying a plurality of candidates of the first information based on the manufacturer information and the model information; and acquiring the first information out of the plurality of candidates based on the operation of the user.

Accordingly, since the first information is acquired out of the selectably displayed plurality of candidates of the first information based on the operation of the user, the first information can be easily acquired with a simple configuration.

(Appendix 8) The image quality control method described in any one of the appendices 1 to 4, wherein the first information includes model information of the first display device.

Accordingly, since the model information of the first display device is acquired, the first image quality information can be easily acquired by selecting one piece of first image quality information out of a plurality of pieces of first image quality information executable by the model indicated by the model information.

(Appendix 9) A non-transitory computer-readable storage medium storing an image quality control program for causing a processor to execute: acquiring first information indicating image quality of a first display device; acquiring second information indicating image quality, which corresponds to the first information, of a second display device different from the first display device from a database that stores the first information and the second information in association with each other; and setting the second information in the second display device.

Accordingly, since the image quality control program described in the appendix 9 has the same configuration as the image quality control method for the display device described in the appendix 1, the same effects as the effects of the image quality control method described in the appendix 1 are achieved.

(Appendix 10) A projector including: an optical device configured to project a projection image; and at least one processor configured to execute: acquiring first information indicating image quality of a projection image of another projector; acquiring second information indicating image quality of a projection image of a projector different from the other projector from a database that stores the first information and the second information in association with each other; and projecting the projection image from the optical device based on the second information.

Accordingly, it is possible to project the projection image of the projector with image quality approximate to the image quality of the projection image of the other projector.

What is claimed is:

1. An image quality control method comprising:
acquiring first information indicating image quality of a first display device;
acquiring second information indicating image quality, which corresponds to the first information, of a second display device different from the first display device from a database that stores the first information and the second information in association with each other; and
setting the second information in the second display device.

2. The image quality control method according to claim 1, further comprising:
the first display device displaying a first image based on the first information; and
the second display device displaying a second image based on the second information.

3. The image quality control method according to claim 1, wherein the first information includes information indicating a first image quality mode for controlling image quality of the first display device.

4. The image quality control method according to claim 3, wherein the first image quality mode is defined by a plurality of setting values preset in the first display device.

5. The image quality control method according to claim 1, wherein the acquiring the first information includes acquiring the first information based on a captured image obtained by capturing an image including the first information displayed by the first display device.

6. The image quality control method according to claim 1, wherein the acquiring the first information includes acquiring the first information based on operation of a user.

7. The image quality control method according to claim 6, wherein the acquiring the first information includes:
acquiring manufacturer information and model information of the first display device based on the operation of the user;
selectably displaying a plurality of candidates of the first information based on the manufacturer information and the model information; and
acquiring the first information out of the plurality of candidates based on the operation of the user.

8. The image quality control method according to claim 1, wherein the first information includes model information of the first display device.

9. A non-transitory computer-readable storage medium storing an image quality control program for causing a processor to execute:
acquiring first information indicating image quality of a first display device;
acquiring second information indicating image quality, which corresponds to the first information, of a second display device different from the first display device from a database that stores the first information and the second information in association with each other; and
setting the second information in the second display device.

10. A projector comprising:
an optical device configured to project a projection image; and
at least one processor configured to execute:
acquiring first information indicating image quality of a projection image of another projector;
acquiring second information indicating image quality of a projection image of a projector different from the other projector from a database that stores the first information and the second information in association with each other; and
projecting the projection image from the optical device based on the second information.
